(19) United States
(12) Patent Application Publication
(10) Pub. No.: US 2002/0156851 A1
(43) Pub. Date: Oct. 24, 2002

(54) Method of enabling an electronic communication apparatus to receive a long e-mail message

(76) Inventors: Cheng-Shing Lai, Taipei Hsieng (TW); Jing-Song Wu, Taipei Hsieng (TW)

Correspondence Address: BACON & THOMAS, PLLC, 4th Floor, 625 Slaters Lane, Alexandria, VA, 22314-1176, US

(21) Appl. No.: 09/836,416

(22) Filed: Apr. 18, 2001

(51) Int. Cl. G06F 15/16

(52) U.S. Cl. 709/206; 709/230

(57) ABSTRACT

A method of enabling an electronic communication apparatus to receive a long e-mail message from an internet server, including the step of driving POP3 (Post Office Protocol 3) of TCP/IP of the network communication software of the electronic communication apparatus to receive the head message of the e-mail message been detected and to send the head message to an upper module block, the step of driving POP3 of the electronic communication apparatus to receive the e-mail message segment by segment subject to the maximum length receivable to the electronic communication apparatus, if the length of the e-mail message surpasses the maximum length receivable to the electronic communication apparatus, and then to send the received e-mail message segments to the upper module blocks one after another, for enabling the upper module block to register the received e-mail message segments in corresponding storage zones and to further connect the e-mail message segments into a complete e-mail message.

### BACKGROUND OF THE INVENTION

The present invention relates to electronic communication apparatus and, more specifically, to a method used in an electronic communication apparatus for enabling the electronic communication apparatus to receive a long e-mail message that surpasses the set length receivable to the electronic communication apparatus.

In recent years, the designing and development of PDA (Personal Digital Assistant) trend to thinner, lighter and shorter size. In order to satisfy consumers' demand, combining a PDA with a regular electronic consumer product is the best way to have great success in market competition. For example, a PDA module and a cellular phone module and/or a fax modem module can be combined together to form an electronic communication apparatus having a wireless telephone function and/or fax function. An electronic communication apparatus with wireless telephone and fax functions can be used to receive e-mail from a server in the Internet. However, an electronic communication apparatus with wireless telephone and fax functions can only receive a limited length of email message at a time. If the length of the e-mail message under receiving surpasses the maximum length receivable to the electronic communication apparatus, the electronic communication apparatus receives only the maximum allowable length, i.e., if the maximum length receivable to the electronic communication apparatus is 20 K, the electronic communication apparatus receives the content of the e-mail message within 20 K and, gives an indication of incomplete receiving of the e-mail message when displaying the e-mail message on its display screen. When in the condition of incomplete receiving of an e-mail message, the user may take one of the following two measures. The first measure is to control the electronic communication apparatus to hold the e-mail message in the network server, so that the user can use a computer communication system, for example, a personal computer to download the e-mail message completely for further reading through the monitor of the personal computer. This measure is complicated because the user must use another Internet communication system to receive the e-mail message again. The second measure is not to hold the e-mail message in the Internet server. In this case, the user can only receive a part of the e-mail message. The rest part of the e-mail message becomes missed.

### SUMMARY OF THE INVENTION

The present invention has been accomplished to provide a method of enabling an electronic communication apparatus to receive a long e-mail message, which eliminates the aforesaid problem. The invention enables the electronic communication apparatus to receive a long e-mail message that surpasses the set length receivable to the electronic communication apparatus.

According to one aspect of the present invention, the electronic communication apparatus divides a long e-mail message into segments shorter than the set length receivable to the electronic communication apparatus, and then receives the e-mail message segment by segment.

According to another aspect of the present invention, the electronic communication apparatus is driven to connect stored message segments to form a complete e-mail message after the email message has been completely received from the Internet server. According to the preferred embodiment of the present invention, the method includes the step of driving POP3 (Post Office Protocol 3) of TCP/IP of the network communication software of the electronic communication apparatus to receive the head message of the e-mail message been detected and to send the head message to an upper module block, the step of driving POP3 of the electronic communication apparatus to receive the- e-mail message segment by segment subject to the maximum length receivable to the electronic communication apparatus, if the length of the e-mail message surpasses the maximum length receivable to the electronic communication apparatus, and then to send the received e-mail message segments to the upper module blocks one after another, for enabling the upper module block to register the received e-mail message segments in corresponding storage zones and to further connect the e-mail message segments into a complete e-mail message.

### BRIEF DESCRIPTION OF THE DRAWINGS

FIG. 1 is an operational flow chart of the present invention.

### DETAILED DESCRIPTION OF THE PREFERRED EMBODIMENT

The invention is to be used in an electronic communication apparatus, which can be a cellular phone, a personal digital assistant, or the like.

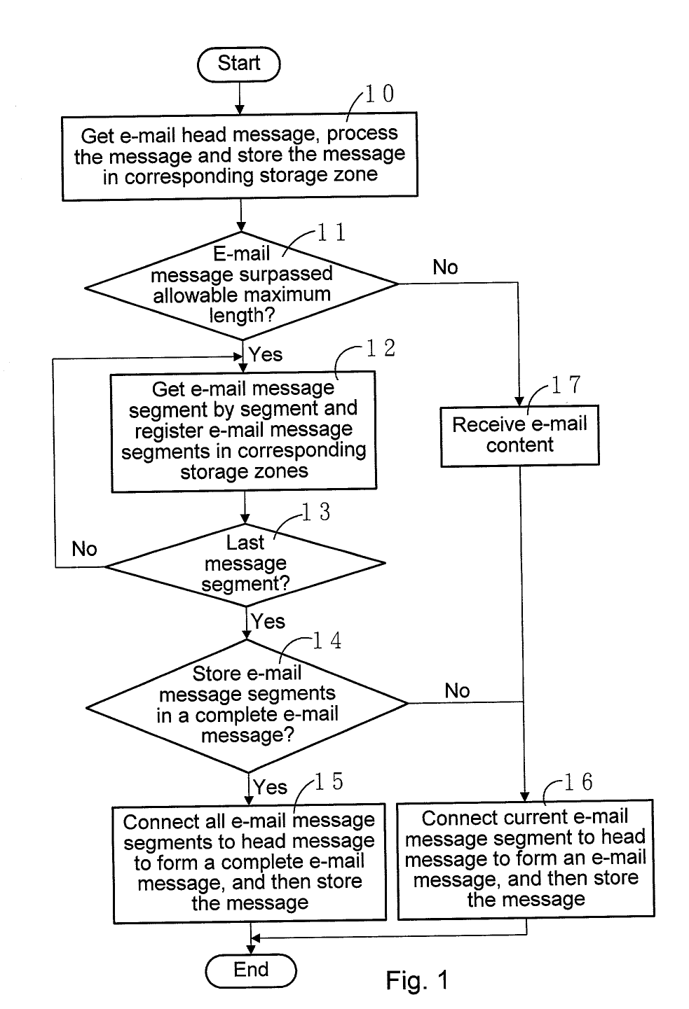

The electronic communication apparatus comprises a CPU (central processing unit), which controls normal operation of the other electronic elements of the electronic communication apparatus, and communicates with an Internet server to receive email message subject to TCP/IP (Transmission Control Protocol/Internet Protocol) in the network communication software installed in the electronic communication apparatus. As illustrated in FIG. 1, the e-mail message receiving procedure includes the steps of:

(10) When POP3 (Post Office Protocol 3) of TCP/IP of the network communication software detected the presence of an email message in the internet server, it immediately receives the head message of the e-mail message and sends the head message to the upper module block, and at the same time gives a message, for example, GETMAILHEAD to the upper module block, enabling the upper module block to process the head message of the e-mail message, and then to use a function to process the e-mail data under receiving;

(11) The upper module block judges, subject to the head message of the e-mail message, if the length of the e-mail data surpasses the maximum length allowable to the electronic communication apparatus, and then proceeds to the next step if positive, or proceeds to step (17) to receive the data of the e-mail message and then to continue the action of step (16) if negative;

(12) Drive POP3 to give a message, for example, GETMAIL-BUFFER FULL to the upper module block, informing the upper module block that the length of the e-mail message surpassed the maximum allowable length, so that the upper module block divides the e-mail message into segments after receipt of the message from POP3, and then drives POP3 to receive the e-mail message segment by segment subject to the set allowable length and to send the received segments of e-mail message to the upper module block in proper order, for enabling the upper module block to register the segments of e-mail message in the corresponding storage zones and to inform the user to link the stored segments of e-mail message;

(13) Give a message, for example, GETMAILED to the upper module block, if the last segment of the e-mail message has been received and detected by POP3, informing the upper module block that all of the segments of the e-mail message have been well received, or continue step (12) if the last segment of the e-mail message has not been received yet;

(14) The upper module block judges if to connect all received segments of e-mail message one after another and to store the message in the form of a complete e-mail message, so as to proceed to step (15) if positive, or to proceed to step (16) if negative;

(15) Connect all received segments of e-mail message into a complete e-mail message, and then store the message;

(16) Connect the received segments of e-mail message with the head message to form an e-mail message, and then store the message.

As indicated above, the electronic communication apparatus receives and stores the incoming e-mail message segment by segment subject to a predetermined length, and then connects the segment data to the head message one after another to form a complete e-mail message, or respectively connects every segment data to the head message to form a compete e-mail message. By means of this message receiving mode, the electronic communication apparatus is free from the limitation of the set maximum data receiving length and, prevents incomplete receiving of e-mail message.

It is to be understood that the drawings are designed for purposes of illustration only, and are not intended for use as a definition of the limits and scope of the invention disclosed.

What the invention claimed is:

1. A method of enabling an electronic communication apparatus to receive a long e-mail message from an internet server, including the steps of:
driving POP3 (Post Office Protocol 3) of the communication protocol of the network communication software installed in the electronic communication apparatus to receive the head message of the e-mail message upon detection of the presence of said e-mail message in said internet server, and to send the head message to an upper module block of said electronic communication apparatus;
driving said upper module block to judge if the length of said e-mail message surpasses the maximum length receivable to said electronic communication apparatus; and
driving said POP3 to receive said e-mail message segment by segment subject to the maximum length receivable to said electronic communication apparatus if the length of said e-mail message surpasses the maximum length receivable to said electronic communication apparatus, and then to send the received e-mail message segments to the upper module block of said electronic communication apparatus one after another, for enabling said upper module block to register the received e-mail message segments in corresponding storage zones.

2. The method of claim 1 further comprising the step of driving said upper module block to connect said e-mail message segments into a complete e-mail message after all e-mail message segments have been received and registered in corresponding storage zones.

3. The method of claim 1 further comprising the step of driving said POP3 to receive the data of said e-mail message if the length of said e-mail message is within the maximum length receivable to said electronic communication apparatus.

4. The method of claim 1 further comprising the step of driving said POP3 to give a message to said upper module block when the last e-mail message segment of said e-mail message has been received, informing said upper module block that all of the email message segments of said e-mail message have been well received.

5. The method of claim 1 further comprising the step of driving said upper module block to receive all e-mail message segments of said e-mail message, and then to connect the e-mail message segments of said e-mail message one after another to form a complete e-mail message for storage.

6. The method of claim 1 wherein said communication protocol of said network communication software installed in said electronic communication apparatus is TCP/IP (Transmission Control Protocol/Internet Protocol).

7. The method of claim 2 further comprising the step of driving said upper module block to connect all e-mail message segments to the head message data one after another to form a complete e-mail message for storage.

8. The method of claim 3 further comprising the step of driving said upper module block to currently received e-mail message data to the head message to form an e-mail message for storage.
